(19) United States
(12) Patent Application Publication
(10) Pub. No.: US 2009/0219376 A1
(43) Pub. Date: Sep. 3, 2009

(54) Internal Drum Image Setter

(76) Inventor: Peter Berner, Rupperswil (CH)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 12/293,278

(22) PCT Filed: Mar. 19, 2007
(86) PCT No.: PCT/CH2007/000151

§ 371 Date: Feb. 19, 2009

(30) Foreign Application Priority Data
Mar. 21, 2006 (CH) 438/06

(51) Int. Cl. B41J 2/47

(52) U.S. Cl. 347/225

(57) ABSTRACT

An internal-drum imagesetter for transferring data to disc-like data storage media has a pickup for arranging the data storage media and a transfer head having at least one transfer means for transferring the data to the data storage medium. In this case, the pickup is advantageously at least partially cylindrical in shape. The side of the data storage medium which is provided for picking up datafaces the cylinder axis of the pickup. The pickup and the transfer head can move relative to one another such that the transfer head can move in the direction of the cylinder axis of the pickup and is arranged so as to be able to rotate about the cylinder axis of the pickup. The transfer means are in the form of violet high-power laser diodes with a wavelength of 405 nm. In addition, the laser diodes are arranged in an easily replaceable laser diode arrangement and they can also be easily replaced individually. This internal-drum imagesetter can also be used to expose conventional offset plates.

The invention concerns an internal drum image setter for the exposure of a plate like data storage medium in accordance with claim 1.

In particular, the invention concerns an internal drum offset plate image setter for conventional offset plates.

In printing technology, because of the overwhelming advantages of digital processes, the so-called CTP (computer to plate) process has taken hold. In particular, drum image setters of various designs have been introduced. In principle, internal drum image setters for the exposure of data storage media using laser diodes are already known in the printing industry in various forms of design.

The WO-98/52345 describes, for example, an internal drum thermal image setter for the transfer of data to a plate-like data storage medium which has a pick-up for arranging the plate and a transfer head as well as at least one transfer means for transferring the data to the data storage medium. The pick-up is at least partially cylindrical in shape and the side of the data storage medium which is provided for picking up data faces the cylinder axis of the pickup. The pickup and the transfer head can move relative to one another such that the transfer head can move in the direction of the cylinder axis of the pickup and is arranged so as to be able to rotate about the cylinder axis of the pickup. The transfer means are in the form of laser diodes which are in a wavelength range of 830 nm which lies outside the visible wavelength range of 380-780 nm and is particularly suitable for the exposure of thermal plates. The simple design of this internal drum image setter ensures high reliability and easy handling. However, conventional offset plates requiring an exposure in the visible wavelength range cannot be exposed using this internal drum image setter. The reason for this is not only with respect to the wavelength range of the laser diodes used but also in the specifications for the associated optics and control electronics which likewise are designed for the infrared range.

The thermal image setter offers significant exposure advantages in all daylight conditions (exposure is not normally affected, etc.) but has the disadvantage that thermo plates are still more expensive than conventional plates in the visible wavelength range.

There are, in fact, solutions allowing digital imaging on conventional offset plates. Among such image setters is the fully automatic UV-setter 710-2 from BasysPrint but this is a flatbed image setter. Its working method is based on the computer to conventional plate (CtoP) system used by BasysPrint. This device uses two imaging heads to increase the exposure speed, a UV light source for the production of polarised ultraviolet light and an electronically controllable grid array (digital screen) with a number of addressable cells, whereby the UV light controlled by individual cells is focused by optics onto the plate to be exposed. As mentioned, the plates here are conventional UV-sensitive offset plates. A disadvantage of this device is that single very powerful and also very expensive UV lamps have to be used.

The goal now is to design an internal drum image setter of simple construction which can expose conventional digital offset plates. In addition, the device should also be cost-effectively adaptable for changeovers in order to be able to be used for both digital thermal exposure as well as for the digital imaging of conventional offset plates.

As cheap and powerful violet laser diodes have also recently become available on the market, the problem can be solved by means of a combination based on a device in accordance with the design as described in WO-98/52345.

The task is solved by the combination of characteristics in accordance with claim 1.

An internal drum image setter for the transfer of data to a plate-like data storage medium which has a pick-up for arranging the plate and a transfer head as well as at least one transfer means for transferring the data to the data storage medium. The pick-up is at least partially cylindrical in shape and the side of the data storage medium which is provided for picking up data faces the cylinder axis of the pickup. The pickup and the transfer head can move relative to one another such that the transfer head can move in the direction of the cylinder axis of the pickup and is arranged so as to be able to rotate about the cylinder axis of the pickup. The transfer means are in the form of laser diodes which have a wavelength of 405 nm and the laser diodes are arranged in an easily replaceable laser diode arrangement allowing them to be easily replaced.

The advantages lie particularly in that conventional very cost-effective digital offset plates can be exposed while the light sources used, namely the laser diodes, are very durable and are very cost-effective both in the acquisition as well as operation and that the device can be monitored and operated with appropriate diagnostic systems (these are not described further here but, in principle, they are known to the expert) in a manner whereby even in the event of failure of a single laser diode, the device remains operational although it works somewhat slower.

Thus diagnostic systems may be combined with control systems in such a way as to allow monitoring and control of the energy output of the individual laser diodes. It also allows for the control of the exposure process depending on the functionality of individual laser diodes.

The internal drum image setter is preferably so designed that the failure of individual laser diodes is detectable by the diagnostic and control system and that subsequent control of the exposure process is feasible at a slower speed, whereby the control is designed so that the largest remaining contiguous block of still functioning laser diodes is used for the exposure. The internal drum image setter is also preferably so designed that the diagnosis and control system is provided with a function for automatic adjustment of the energy output following the replacement of a faulty laser diode.

Thus semiconductor lasers in the form of laser diodes are preferred as light sources or as a means of transfer. Preferably these laser diode arrays have, for example, 32 or 64 laser diodes. The higher the number of laser diodes, in principle the higher the achievable exposure rate for the plate-like data storage media.

The cost-effective convertibility is particularly achieved in that the laser diodes are arranged in one or more easily removable laser diode arrays. Thus the individual laser diodes are also easily interchangeable. This easy interchangeability means, for example, that either laser diodes with a wavelength of 405 nm or laser diodes with a wavelength of 830 nm can be used. Thus the internal drum image setter not only has the desired flexibility for exposure of different plate materials but the easy interchangeability of individual laser diodes also facilitates rapid trouble-shooting.

This easy interchangeability may be considered from two aspects. In the case of the replacement of one or more laser diodes following failure, the easy mechanical interchangeability of the laser diode arrays or individual laser diodes is still supported by the above-mentioned function whereby the diagnosis and control system has a function for automatic adjustment of the energy output following the replacement of a faulty laser diode. This greatly reduces the offset plate exposure downtime because remedying the problem does not require any specialised maintenance personnel to be involved. In the case of replacement of laser diodes as a result of a planned upgrading of equipment to a different wavelength, the same advantages apply, of course, but, in this case, the exposure optics generally have to be adapted (see also further embodiments below).

High-performance laser diodes in a wavelength range of 405 nm and with a peak power of up to 140 mW in pulsed operation are offered, for example, by Nichia. Thus conventional UV-sensitive offset plates may also be exposed. The performance figures relate to today's commercially available laser diodes but, of course, these can be adapted for future applications when the use of more powerful laser diodes may be considered (insofar as they are available). Laser diodes for other wavelengths, for example, 830 nm, i.e. in the near infrared range, have been used for a long time for the exposure of thermal plates (see the above-mentioned prior art).

With respect to the provision of an offset plate image setter which can be easily adapted for use with various plate types, the optics must also be taken into account and in the case of optics suitable for widely different wavelength ranges, sufficiently good optical performance is so expensive that their use in internal drum image setters is out of the question. It is therefore considered necessary, either to use interchangeable optics or an internal drum image setter with at least two optics, whereby as in the previous case, at least one of these optics must be capable of transmitting the wavelength of 405 nm. Of course, optics may also be used which are suitable for transmission of other wavelengths in addition to the wavelength of 405 nm.

In the present application, the exact description of technical details such as the computer control of the imaging system, the transfer of data to the rotating means of transfer (such as by using fibre-optic cables), the electrical contact by means of sliding contacts have been waived in the interests of brevity of the application. The solving of such detail problems corresponds, of course, to the knowledge and skills of a professional entrusted with such a task.

1. Internal drum image setter for the transfer of data to a plate-like data storage medium which has a pick-up for arranging the plate and a transfer head as well as at least one transfer means for transferring the data to the data storage medium. The pick-up is at least partially cylindrical in shape and the side of the data storage medium which is provided for picking up data faces the cylinder axis of the pickup. The pickup and the transfer head can move relative to one another such that the transfer head can move in the direction of the cylinder axis of the pickup and is arranged so as to be able to rotate about the cylinder axis of the pickup and the transfer means are in the form of laser diodes, characterized in that the laser diodes are high performance laser diodes which have a wavelength of 405 nm and the laser diodes are arranged in an easily replaceable laser diode arrangement allowing them to be easily replaced.

2. Internal drum image setter according to claim 1, characterized in that the laser diodes have a minimum power of 100 mW, preferably at least 140 mW.

3. Internal drum image setter according to claim 1, characterized in that the transfer head has optics which are suitable for the transmission of a wavelength 405 nm or which are also suitable for the transmission of other wavelengths in addition to the wavelength of 405 nm.

4. Internal drum image setter according to claim 1, characteized in that the transfer head has two optics, one optics of which is suitable for the transmission of a wavelength of 405 nm.

5. Internal drum image setter according to claim 1, characterized in that a number of laser diode arrays is available, each with a number of laser diodes.

6. Internal drum image setter according to claim 1, characterized in that the laser diodes are individually easily interchangeable.

7. Internal drum image setter according to claim 1, characterized in that the internal drum image setter has a diagnosis and control system for monitoring and control of the energy output of the individual laser diodes and control of the exposure process depending on the monitoring function.

8. Internal drum image setter according to claim 7, characterized in that the failure of individual laser diodes is detectable by the diagnostic and control system and that subsequent control of the exposure process is feasible at a slower speed, whereby the control is designed so that the largest remaining contiguous block of still functioning laser diodes is used for the exposure.

9. Internal drum image setter according to claim 7, characterized in that the diagnosis and control system is provided with a function for automatic adjustment of the energy outputs following the replacement of a faulty laser diode.
